(19) United States
(12) Patent Application Publication
(10) Pub. No.: US 2022/0279812 A1
(43) Pub. Date: Sep. 8, 2022

(54) Methods and Apparatus for Producing Protein and Fiber Concentrates from Spent Grain

(71) Applicant: Librixer AB, Göteborg (SE)

(72) Inventor: Eric L. Lundgren, Västra Frölunda (SE)

(21) Appl. No.: 17/632,494

(22) PCT Filed: Jul. 29, 2020
(86) PCT No.: PCT/EP2020/071392

§ 371 Date: Feb. 3, 2022

Related U.S. Application Data
(60) Provisional application No. 62/883,460, filed on Aug. 6, 2019.

(51) Int. Cl. A23J 1/00; A23J 1/12; A23L 7/10; A23L 7/20

(52) U.S. Cl. CPC A23J 1/005; A23J 1/12; A23L 7/115; A23L 7/20

(57) ABSTRACT

A method for obtaining one or more fiber rich and one or more protein rich fractions from spent grain, SG, the method comprising: dehydrating (S1) wet spent grain, WSG, into dehydrated spent grain, DSG, by arranging the WSG on at least one dehydration surface, wherein the dehydration surface comprises a net with apertures arranged to allow air to penetrate without the spent grain falling through, and wherein a conditioned air movement system is arranged to move air over, under the dehydration surface as well as through the apertures, and comminuting (S2) the DSG by a comminution reactor comprising a spinnable shaft and two or more processing chambers, separated by segmented divider plates, wherein each processing chamber comprises one rotor disc attached to the shaft and one or more vortex generators placed at respective apex corners of stationary side walls of the processing chambers, wherein the DSG is fed into the comminution reactor and fiber-rich and protein-rich fractions are liberated from the DSG by means of a non-linear vortex flow of DSG and liberated products generated in the processing chambers.

### TECHNICAL FIELD

The present disclosure describes methods and systems for dehydration of wet spent grain source materials, followed by liberation and concentration of proteins and fibers from spent grains, commonly generated as high volume by-products from either ethanol or beer production.

### BACKGROUND

Brewer's spent grain and Distiller's spent grain, both herein commonly referred to as spent grain (SG), consists mainly of water, protein, fibers, fat and ash. It is one of the major by-products generated by these industries. The SG producers are mostly located in rural areas near where the starch feed materials; corn and other grains, are grown. Their rural locations have naturally offered opportunities to sell the SG, either wet or dry, as animal feed for value of around 40 USD per ton wet grain, containing around 60% water. However, many breweries are located in metropolitan areas and do not have the same opportunity to find a local market for their by-products. Therefore their SG often finds its way directly to local landfills. Thus, this nutritionally rich food source is not fully utilized despite its high protein, fiber, and fat levels.

The world's ever-growing population is constantly seeking new and more efficient sources of protein and yet this very large volume of excellent protein and fiber by-products from enzymatic starch to sucrose production remains mostly un-tapped. This is partially due to old habits but also until recently there has been a lack of scalable commercially viable methods to deal with these large volumes of nutritional by-products.

Recent increased interest in suitable plant proteins to replace traditional animal proteins has further focused interest on this relatively un-tapped resource specifically for human consumption. About 300,000 tons of SG is generated annually by the brewing industry alone. It represents around 60,000 tons raw protein enough to satisfy 1.3 million peoples need for an entire year.

There is a need for improved methods for utilizing SG, which allow humans to tap these new sources of valuable plant proteins and potentially also the fibers in SG.

### SUMMARY

It is an object of the present disclosure to provide new methods to stabilize, liberate and separate fibers and protein from SG to be used, e.g., as new nutritional sources for human consumption.

This object is obtained by a method for obtaining one or more fiber rich and one or more protein rich fractions from spent grain (SG). The method comprises dehydrating wet spent grain (WSG) into dehydrated spent grain (DSG), by arranging the WSG on at least one dehydration surface, wherein the dehydration surface comprises a net or other planar structure with apertures, such as holes, arranged to allow air to penetrate without the spent grain falling through, and wherein a conditioned air movement system is arranged to move air along above and below the dehydration surfaces, through the apertures and past the SG. The method also comprises comminuting the DSG by a comminution reactor comprising a spinnable shaft and two or more processing chambers, separated by segmented divider plates, wherein each processing chamber comprises one or more rotor discs attached to the shaft and one or more vortex generators placed at respective apex corners of stationary side walls of the processing chambers, wherein the DSG is fed into the comminution reactor and fiber-rich and protein-rich fractions are liberated from the DSG by means of a non-linear vortex flow of DSG and liberated products generated in the processing chambers.

This method allows liberation and removal of fibers in the SG. The removal of low protein content fibers will automatically increase the protein concentration in the other remaining portion of the processed material. To be able to do this successfully, it is important that the necessary dehydration of the SG is done smartly so that the fibers, protein, and fat is not “welded” together. Instead, by using a gentle ambient temperature system for dehydration, all structures are gently collapsed without being “glued” together.

The different components of the SG are gently liberated from each other without micronizing the brittle fibers. After liberation, the fibers can be removed by different means of separation based on, e.g., particle size and/or particle density or in an air aspirator based on respective particle behaviors in an introduced air stream with vacuum. As the fiber structures are removed, since they contain very little protein, the protein concentration in the remaining material is increased. The end result is a high fiber purity fraction and a high protein fraction which can be used, e.g., as new human nutritional sources. The methods disclosed herein are capable of generating an end result with over 40% protein concentration and only a loss of protein in the fiber fraction of around 5% protein by weight resulting in a high yield of protein capture.

According to aspects, the method further comprises centrifuging the WSG to remove surface water before the dehydration step. It is preferred to lower the moisture level to a point where there is a minimum of surface moisture left on the SG. This can be checked in a straightforward manner by, e.g., hand squeezing where suitable moisture level in the wet SG will only result in a few drops of water when compressed by hand.

According to aspects, the conditioned air movement system comprises an input duct below the lowest placed dehydration surface L arranged to exhaust dehumidified air, one or more fans arranged to push the dehumidified air along below and above and through the dehydration surface for picking up moisture from the WSG, all placed inside a closed tunnel, to create a closed loop system of dehydration space and airducts arranged to evacuate air with high moisture content, lead it into a dehumidifier, and thereafter lead it back to the input duct. This type of conditioned air movement system is a gentle ambient temperature system for dehydration which ensures that all structures are gently collapsed staying soft and flexible as the water leave the structure without being glued together. Traditional heat based drying systems, on the other hand, tend to leave conglomerates of bonded brittle components with a light burned flavor, that both degrade the quality initially and later makes mechanical liberation and concentration significantly more challenging with the result of lesser concentration, lower yield as well as lower protein and fiber qualities.

According to aspects, the air inside the conditioned air movement system is arranged to be ionized for air purification and food safety. The ionization will neutralize spores and molds as well as many bacteria in the warm moist air being conditioned.

According to aspects, the at least one dehydration surface is arranged to constantly role around to keep the components of the WSG from being bonded to each other. Another aspects of the method is WSG and the DSG being loaded onto and unloaded of, respectively, the dehydration surface automatically. This increases the efficiency of the overall process. An automated process requires fewer persons to operate, which could be an advantage in regions where labor cost is high.

According to aspects, the method further comprises separating ultra-fine protein/bran structures from larger protein/bran structures and fibers of the liberated products by an in-line separation arrangement consisting of one or several vertically placed baffles. Thus, an efficient and reliable method for separating ultra-fine protein/bran structures from larger protein/bran structures and fibers is provided. The separation arrangement may be a discharge arrangement comprising a main cylindrical cone shaped chamber extending along a main axis. The main chamber having an inlet arranged to be fluidly connected to the comminution reactor and an outlet at the bottom of the cone arranged opposite from the inlet along the main axis and closeable by a common material take-out valve. The main chamber is arranged to support a fluid-material stream comprising a mix of air and liberated products along a spinning circular path about the main axis from the inlet towards the outlet. The discharge arrangement may further comprise an airduct arranged extending into the main chamber at an acute angle with respect to the main axis, the airduct comprising an aperture arranged facing the outlet, whereby a portion of the fluid-material stream, comprising the ultra-fine protein and bran structures and air, changes direction from the fluid-material stream about the main axis from the inlet towards the outlet to a flow inside the airduct and is thereafter arranged to be collected in an ultra-fine particle separator, and wherein the larger protein/bran structures and the fibers are forced by the design and placement of the airduct to drop out from the main air flow, to be collected via the take-out valve.

According to aspects, the method further comprises separating the ultra-fine protein/bran structures into heavier and lighter fractions by arranging the ultra-fine particle separator to comprise one or more baffles arranged to restrain the upwards-flowing mix of air and liberated products, and by terminating the ultra-fine particle separator and air by a filter bag house. This way different fractions are conveniently obtained in different stages inside each baffle. The benefits of the disclosed methods include that a majority of the fine particles such as SG's small protein structures can be smartly removed without further addition of complicated and expensive equipment with the assistance of an already created air movement and without further addition of energy.

According to aspects, the method further comprises separating the larger protein/bran structures from the fibers on a traditional shaker screen or other similar function air classifier. Shaker screens and air classifiers are well known to provide an efficient separating function.

According to aspects, the method further comprises gently crushing the DSG after the dehydration step and before the Librixer liberation and size fractionation step. This makes transportation and storage of the DSG more efficient, and also improves the liberation process results.

The dehydration systems, comminutor reactors, devices and systems disclosed herein are associated with the same advantages as discussed above in connection with the different measuring devices. There are furthermore disclosed herein control units adapted to control some of the operations describes herein. Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 is a block diagram of a system for dehydration, liberation, and concentration of both protein and fibers in SG in accordance with embodiments of the present disclosure.

FIG. 2 is a block diagram of an ambient temperature dehydration system and illustrates methods based on a closed loop tunnel air dehydration.

FIG. 3A is a schematic drawing of a Librixer particle liberator/micronizer with an in-line ultra-fine particle size classifier in accordance with embodiments of the present disclosure.

FIG. 3B is a schematic top view drawing of an example Librixer liberator/micronizer process chamber schematically illustrating how the different counter rotating vortexes interact with each other inside the process chamber.

FIG. 4 schematically illustrates an ambient temperature dehydration tunnel, describing its main functions and general design with stationary dehydration surfaces for drying SG from, e.g., a brewery or a distillery.

FIG. 5 is a flow chart illustrating methods which summarize the disclosure.

FIG. 6 schematically illustrates a control unit.

FIG. 7 shows a computer program product.

### DETAILED DESCRIPTION

Aspects of the present disclosure will now be described more fully with reference to the accompanying drawings. The different devices and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

It is with the above background, lack of present known technologies and methods and with current changes in public attitudes that we no longer can accept valuable nutritional resources going to waste in a modern circular economy. The present disclosure describes how spent grain protein and fiber can be preserved using a low capital cost and low energy consumption preservation system for dehydration followed by a liberation process to separate fibers from protein via a gentle pass through the Librixer system. A device similar to the Librixer system is described in EP2571620A2.

Due to the unique functionalities of Librixer comminutor system, the dried and liberated components of the SG can be separated and concentrated by methods known in the art, such as mechanical separation and concentration methods. The present disclosure provides methods, devices, and systems for safe keeping, liberation of protein and fibers and separation of these from each other resulting in high yield and high concentration protein and fiber fractions from spent grains, such as brewers spent grains and/or distillers spent grains. In a main embodiment such liberation and concentration are accomplished in an all-dry process. The disclosed process does not require chemical treatments, rinsing, associated with high levels of water consumption, which is an advantage. Instead the disclosed methods are associated with the production of clean potable water from the dehydration process. This produced water may replace a significant volume of consumed water within the same industries, thereby lowering overall water consumption.

Typical spent grain can hold up to 65% moisture prior to dehydration. Stable SG, i.e., dried spent grain (DSG), can food safely contain on the order of 8-10% moisture, by weight. It is cost efficient to seek the highest possible food safe moisture content. It requires unnecessary cost or time to strive for an absolutely dry SG. A food safe moisture level of 8-10% is the most efficient level from many aspects, not just regarding cost and time, but also, because overly dry products tend to take on electric charges which makes mechanical separations between protein and fibers more complicated. The most common obstacle to overcome in using SG as a valuable food resources is CAPEX and OPEX associated with dehydration of the raw material followed by commercially viable methods to remove fibers to achieve the desired protein content result.

Herein, particle sizes are referred to using relative terms, such as small, medium, and large. It is appreciated that absolute size values can be determined by straight forward experimentation or from literature. In the present disclosure, relative sizes are deemed more appropriate in order to not obscure the general inventive concept.

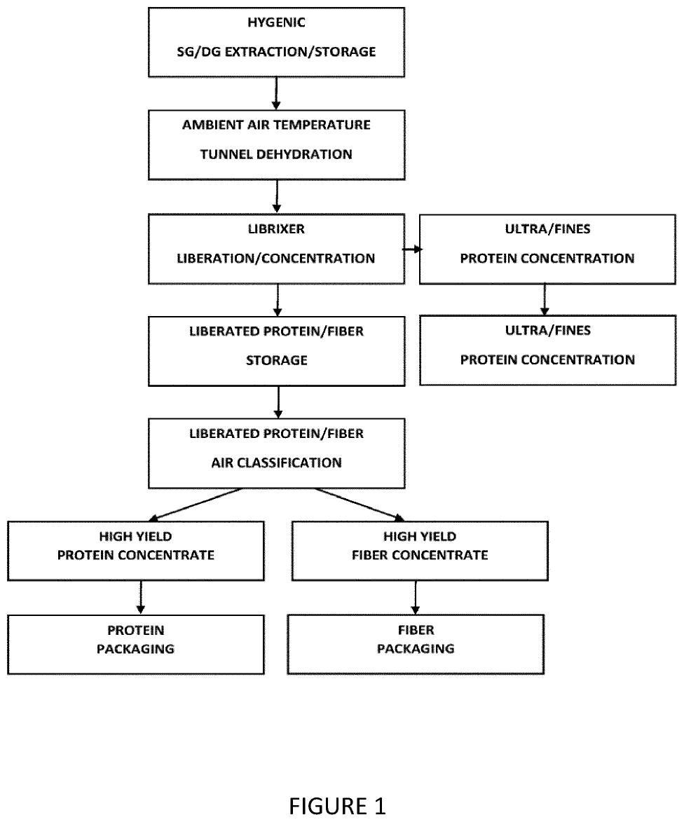

FIG. 1 shows a block diagram of spent grain protein and fiber dehydration, liberation and concentration. The most common starch source used in beer production is malted grain from barley. There are exceptions to this general rule where rice or corn are used as starch sources. Traditionally the barley gran is malted by soaking it in water. The beer malting process regionally uses barley with the husk attached. Husk or no husk is commonly based on brewing system and desired product flavor. This remaining husk is the main reason for the high fiber content in the SG. By soaking the grain in water at a suitable temperature, the germ is ‘tricked’ into thinking it is time to germinate and the enzymatic conversion from starch to sucrose therefore starts. This process is commonly then stopped by drying the malted cereal in a kiln. The purpose of the malting is to produce enzymes that convert starches in the grain into fermentable sugars. The SG from ethanol production by distilleries is commonly sourced from corn and milled finer giving a less fiber rich final SG with commonly smaller fibers compared to the fibers in SG from beer production.

Some of the methods presented herein start with a hygienic extraction process depending on the actual pre-process configuration. Such “Hygienic Extraction” process may include storage systems and a metallic redress system. In some embodiments the received SG may need to be dewatered of surface water to reduce its moisture level using for instance centrifuges for surface water removal. It is preferred to lower the moisture level to a point where there is a minimum of surface moisture left on the SG. This can be checked in a straightforward manner by, e.g., hand squeezing where suitable moisture level in the wet SG will only result in a few drops of water when compressed by hand. The system may contain food grade interfaces as well.

The moist SG, in the novel methods herein described, are spread out on a dehydration surface. The dehydration surface consists of a stationary framed screen with suitably sized apertures (holes) or a movable band screen allowing air to penetrate without the product falling through the holes. In one such preferred embodiment inspiration from the baking industry have yielded a set-up of standard baker's racks where the dehydration surface are custom designed and fabricated dehydration surfaces made from framed screen rack fitting the normal bakers tray slots in the racks. It is furthermore possible to mold a custom dehydration surface structure that automatically can be loaded and stacked by robots creating movable dehydration racks. Each square meter of dehydration surface can be loaded with several kilos of wet SG in a 2-5 cm thick layer. The moisture level of the source SG may vary based on location and source material within each location. The safe target for dryness is less than 8-10% remaining moisture so that the dried SG is stable for long term ambient temperature storage.

It is also a possible consideration to accept even higher moisture levels of the dehydrated SG if the liberation in the Librixer can be close to the dehydration ambient air tunnel system and process in the Librixer can be accomplished within the time frame allowed by all factors considered to maintain a safe food source. The reason for such consideration is obvious time and energy savings. Instead of seeking 8-10% moisture, starting the liberation step at for instance 20% moisture level could shorten the dehydration time with upwards 50% and as such increase the capacity of the dehydration tunnels with 100%. This additional moisture will then be blown off during Liberation in the Librixer assisted by the significant airflow needed through the Librixer. The functionality of the Librixer is such that the increased need for further drying mean that the liberated fiber components sizes and characters are maintained throughout the process. Increased entry moisture level will make the fibers more flexible and durable to resist micronization. This characteristic with fibers can be utilized efficiently with smaller fiber structures from SG generated by the distiller using different starch sources and grinding the feed stock harder and thereby resulting in smaller fiber structures. For either SG source a gentle moisturizing using tap water or analyte water just prior to Librixer entry already small as well as large fiber structures can be better size preserved during the liberation in the Librixer.

One ton of wet SG source material can be estimated to contain around 600 liters of water and 400 kg of dry material. With an accepted remaining moisture level of 8-10% by weight in the finished “dry” SG: around 550 liters of potable water can be retrieved during dehydration and reused in the brewing or distilling process. It should be mentioned that this water is pure and ready for human consumption or industrial use.

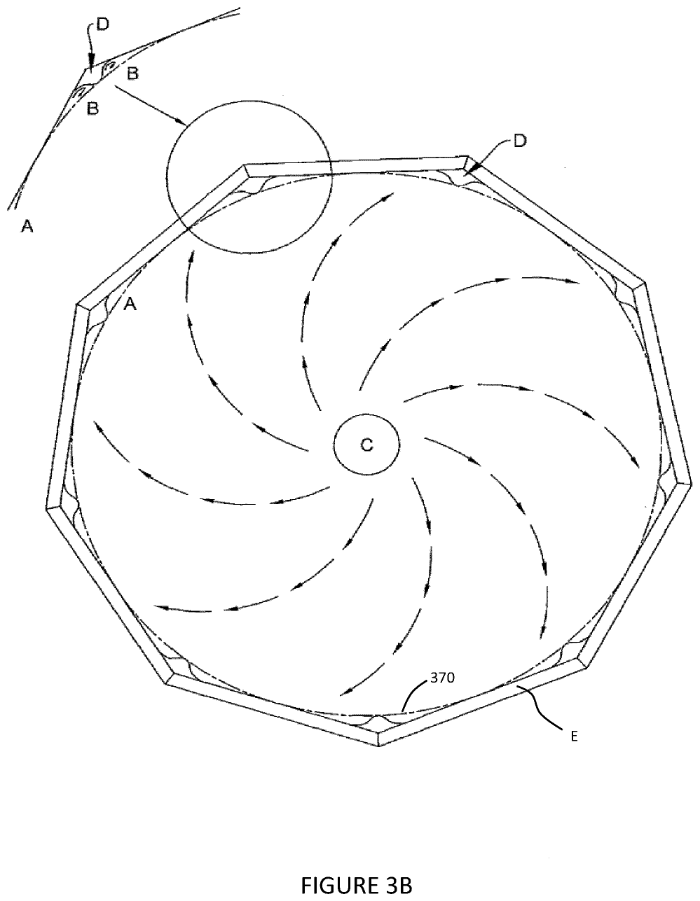

The ambient temperature dehydration process discussed herein is trading space, time and convenience for low cost, higher quality, and less carbon footprint when compared to traditional drying by forced air heat or infra/red heat drying systems. The disclosed embodiment is a batch process that is operating non-supervised, preferably during non-normal business hours, controlled and fed by a modern super-efficient air dehydration system and fan driven conditioned air movement system. One such dehydration system, which will be discussed in more detail in connection to FIG. 4, consists of a sealed rectangular room 15 meter by 20 meter that can be emptied and reloaded once every 24 hours or so. The combined dehydration surface inside such sized tunnel, can be made to exceed 6,000 m2 and can take well over 5 tons of wet SG every 24 hours.

After dehydration, the dry conglomerated “bundles” of SG are gently compacted and either packaged for transportation to an off-site protein-fiber liberation/concentration facility or stored in dry SG silos on-site for further processing. The finished dried SG commonly consists of 8 to 10% moisture, around 30% protein, around 50% fiber while the rest is made up of, e.g., carbohydrates, ash, and fat.

The methods disclosed herein relate to dry or lightly moisturized dehydrated SG and separation concentration of protein and fibers into one fiber rich and one protein rich fraction of the dehydrated SG. The method for such liberation and separation in the “Librixer-SG” according to an embodiment of the present invention includes feeding the SG into a liberator/micronizer invented by one of the inventors to this method. The Librixer is a unique 360-degree micronizer/liberator that tends to not only micronize brittle materials but also liberate different components along natural boundaries. One such very simple composite structure can for instance be dried SG where the different components such as the protein and fibers simply became attached to each other during the normal process of either making ethanol or beer or dehydration of the same. Known milling techniques and apparatus, such as roller, hammer, and ball mills, are generally based on either impact, shear or compression forces or a combination thereof. These forces mimic what nature has done for millions of years. A typical example of a natural milling process is a river gradually breaking down riverbed rocks to finer granules or sand. Nature, as well as traditional milling techniques, tend to create variably sized round particles with passive surfaces. Biological materials such as cell structures are broken, and its interiors spilled and exposed to degradation. The Librixer 360-degree comminutor liberates such and other materials along natural boundaries while keeping the liberated structures intact. Its operating results lends itself perfectly to the task of liberating protein and fibers in SG.

Most of the fibers in the SG are from the barley husk and the barley bran left behind while the barley starch is consumed during the normal brewing process. The remaining protein source in SG is commonly either the inner layer of the barley bran or remaining structures from the barley endosperm, non-starch, not consumed during starch to fermentable sugars conversion and possibly some dead yeast to mention a few.

The operating parameters, consisting of rotation speed and rotation direction and feed rate, on the Librixer are set to optimize the finished liberation while minimizing any particle size change. With the Librixer operating parameters properly set and feed rate trimmed: almost all fiber will be kept intact during the pass through the Librixer and exit in the same condition and sizes as entered. The small protein structures do not need to be further micronized just liberated from these fibers. The gentle internal liberation forces generated by the Librixer makes the larger fiber structures vibrate and shake and hereby release the smaller protein structures freely into the air fluid stream. Most of the ultra-fine protein structures are attached to the smaller bran particles while others are free. These small structures can be separated away from the main material stream of fibers to instead follow the main airflow generated by the Librixer and collected in the Librixer ultra-fine particle separator/-s, while larger protein structures together with the fibers are collected and discharged via an airtight rotary valve at the bottom of the Librixer discharge cone.

The main material flow consisting of most of the fibers and the remaining proteins are then stored in a process silo before final particle polishing where the larger protein/bran structures are further separated from the fibers in a commonly known shaker screen arrangement or air classifier or the like. Since the ultrafine particles already have been separated via the in-line air flow system classifier of the Librixer, the remaining larger protein/bran structures and the, by comparison, very large fiber structure, such as the husk can now successfully be separated from each, without being hindered by these very small protein and fiber structures.

The air dehydration, librixer protein and fiber liberation/separation, and initial mechanical separations between protein and large fiber results in three possibly finished or staged for further downstream concentrations product fractions:
A. Protein high concentrate of ultra-fine particles collected directly from the Librixer in-line separation system. This fraction has a protein concentration level of over 50%. Its fine flour consists of small protein structures, clean small bran structures, and conglomerates of bran with attached protein layer.
B. Protein flour/concentrate collected from the product screening. This fractions received as smallest particle size fraction from initial shaker screening or similar technology also consist of protein mixed with bran but free from the large husk fiber structures.
C. Fiber concentrate is collected from the product screening's largest sized fraction. Very little protein is present since this fraction contain a majority of the husk.

The SG conglomerates prior to liberation and separation vary in their content based on malt or mesh starch source and processes. As illustration the following general content mix can normally be estimated:
Protein 25%
Fiber 55%
Fat 8%
Moisture 7%
Ash 5%

The industry commonly discusses the following terms and concentration for protein sources:
A. High protein flour with a raw protein level between 40-60%. The rest is commonly fiber, moisture, fat, and ash.
B. Protein concentrate with a raw protein level of 60-80%. This level can be achieved by further processes beyond the scope of these presented methods.
C. Protein Isolate with a raw protein level of over 80%. Accomplished by further chemical processes again beyond the scope of these presented methods.

The commercial value of both a fiber and a protein concentrates are based on concentration level, quality, source, and character. The actual performance of a mechanical protein and fiber concentration method is based on cost, quality, process conditions and demand.

The methods disclosed herein comprise a gentle dehydration, liberating fibers from dried SG in the Librixer, followed by mechanical separation between fibers and protein in one or more steps based on known art such as shaker screens and/or air density classifiers. Where in one or more down-stream steps liberated fibers are removed by known technologies, such as shaker screens and/or air aspirators, to create an ever increased concentration of protein, whereby automatic the other fraction will be an ever increased volume of a fiber concentrate.

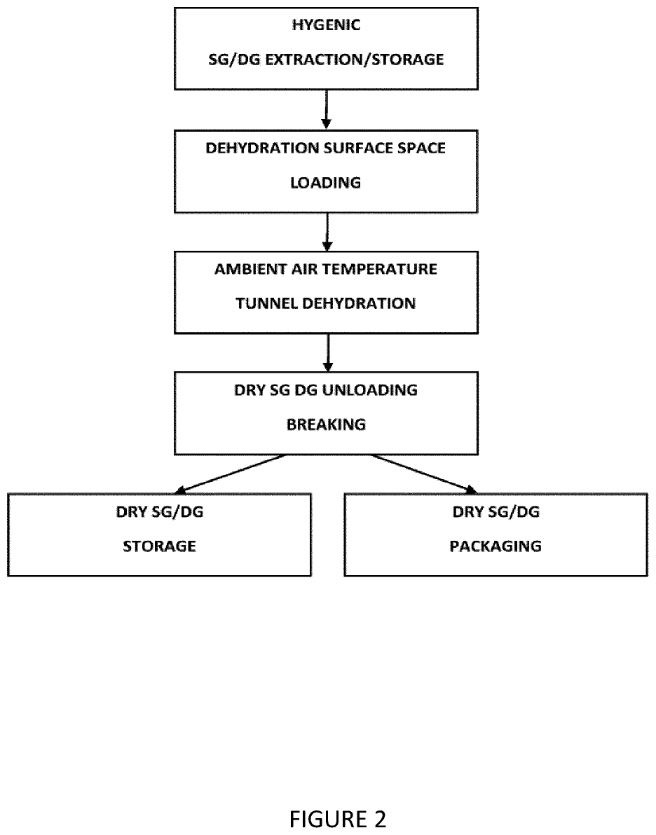

FIG. 2 is a block diagram of an ambient temperature dehydration method based on closed loop tunnel air dehydration embodiment. There are many different known technologies for preserving materials such as SG by drying down the moisture content to a food safe level. Such level is unique for each material and environment but is most commonly reached at around 8% remaining moisture. Many such systems are based on one or another form of hot air or infra-red heat technologies. Such systems tend to have extremely high capital cost combined with high operating cost and significant negative environmental impact. Furthermore high heat rapid dehydration tends to scorch the product and leave a slight bitter burned flavor of the finished product not to mention that many food nutrients can be negatively affected by the high heat even if the process time is short. Comparative tests between dehydrated spent grain (DSG) from this presented method of ambient temperature dehydration with traditional high heat drying have shown that the rapid high heat dehydration quickly removes the moisture making fibers, fat, ash, and proteins quickly collapse and impossible to gently liberate from each other without also making the individually components very small and hard if not impossible to concentrate. It is a preferred embodiment of this method to trade the high capital and operating cost drying for a more efficient, in-tune with nature system based on adaptation and improvements of well-known very old dehydration techniques. Large commercial air dehydration units have in the last 5 to 6 years become ten-fold more efficient when considering energy needed per liter of moisture removed from an airflow. By using a system operating in harmony with nature and trading speed for space, large volumes of SG can be dehydrated in a batch process, harvested, and re-loaded every 24 hours. The present embodiment is based on a certain load of wet SG applied to a custom designed netting in a frame and stacked vertically on movable racks like common baker's rack and trays in the baking industry. Many such loaded racks are then placed in a large, enclosed, slightly elongated tunnel where the conditioned air is entered via a duct along the floor along one elongated side of the enclosure. Several fans push the air across and as the air picks up moisture it become lighter and raises upwards. The moist air is then evacuated at the top across the tunnel from the inlet side. The evacuated air leaving the tunnel is dehydrated, and optionally also ionized, before entering back into the dehydration unit for further water removal. Such ionization process will guarantee a food safe environment inside the tunnel during the entire dehydration period of 24 to 36 hours.

When the internal moisture in the SG has reached safe food levels, i.e., on the order of 8-10% by weight, all racks are harvested, i.e., emptied, and the dry SG is then optionally gently de-crumbled for more efficient storage and/or transportation, while at the same time another load of wet SG is loaded on all the trays and the custom designed trays are inserted into the racks again. The same process can be repeated for each day and every tunnel. It is also feasible to further automatize the entire dehydration process by using a rotating dehydration surface like a slow rotating drum inside the ambient temperature dehydration tunnel.

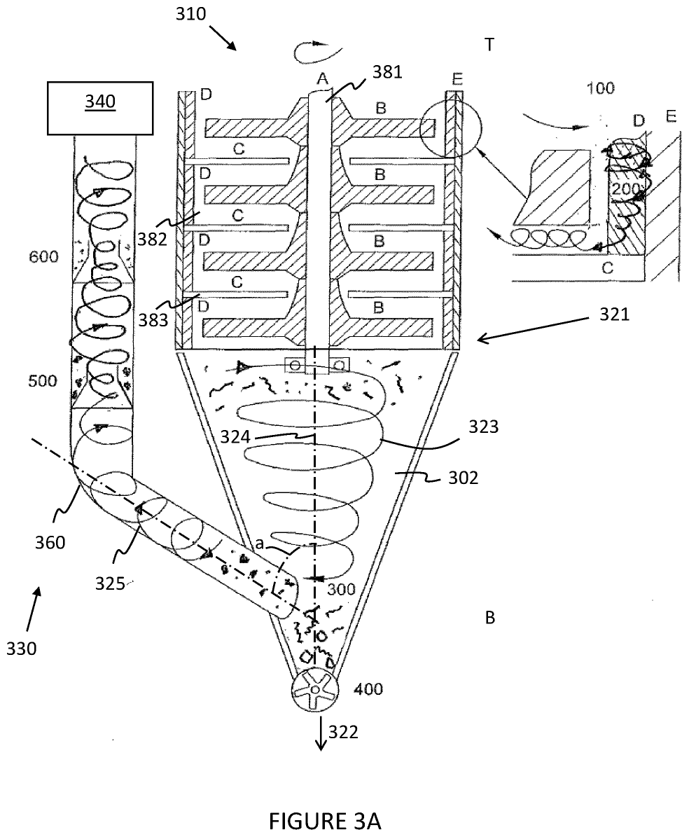

FIG. 3A is a schematic drawing of a Librixer small particle liberator/micronizer system with an air/duct ultra-fine particle size classifier in accordance with the embodiments of the present disclosure. A device similar to the Librixer system is described in EP2571620A2. The spent grain from either a distiller's or a brewer's operation is introduced on top of the upper most spinning rotor “B” via an inlet feed port in the housing (not shown here). The air and SG mix is rapidly forced outwards towards the stationary sidewall “E”. With reference to FIG. 3B, the same force from the spinning rotor initiates a spinning motion around an inscribed circle 370 restrained by an odd number of flat wall sections (Here 9 such wall sections shown). The design of the rotor assembly, as the individual skilled in such art will realize, injects different levels of forces into the fluid stream consisting mostly of air and the dried SG. One side of the vanes is convex and obvious the other being concave will have different power requirements for rotation and interact more violent and less violent with the fluid stream, based on rotation direction clockwise or counter-clockwise within each stage in the Librixer.

A top side of the Librixer is indicated as T, while a bottom side is indicated as B. A part below another part is located closer to the bottom than the top, and vice versa.

As this circular flow reaches one vortex generator located in every one, or just some, of the odd numbered apex corners, some of the main material flow becomes entrapped and re/directed into spinning in the opposite direction to the main flow of particles on each side of the vortex generator “D”, see the insert in FIG. 3B. The gap between rotor edge “B” and the vortex generator “D” is the field within most of the liberation/micronization happens. As these two material streams interact with each other via rapid change of directions, dramatic pressure differences, and/or collisions with each other and the equipment each member particle of a conglomerate such as dehydrated spent grain, DSG, tend to be liberated from each other along natural boundaries. As these particles spins around inside and along a vast number of such vortexes, they tend to become less dense and eventually when they have become light enough, they are sucked down into the next chamber by that chambers lower pressure. Brittle material tends to come down to smaller sizes, while more flexible materials such as fibers tends to bend and adjust and basically stay the same size unless significantly higher energy is injected into the process. With reference to FIG. 3A, the process of liberating protein and fibers from each other in SG is accomplished at very low energy levels to minimize further micronization of the material. The processes are then repeated in the following stages (or processing chambers) until finally the air and liberated protein and fiber is ejected from the last process chamber into the attached discharge cone.

In an additional embodiment of the present invention, it is possible to smartly moisturize the DSG before entering the Librixer liberation equipment. This could be potentially very important should the fiber content in DSG be very dry and brittle. A quick misting of the DSG surface, before entering the Librixer, with either regular tap water or preferably analyte water will quickly make the DSG fiber structures more flexible and less destined to become micronized and using analyte water will further secure food safety. The reason for this concern is that small fiber structures are significantly more complicated to separate and concentrate than larger fiber structures in a protein fiber mix.

The rotation speed setting for successful liberation depends on the number of process chambers and the actual physical size of each processing chamber. A Librixer can have anywhere from just a few process chambers upwards to 6 or more chambers, each equipped with a horizontally rotating rotor and an odd number of vortex generators. The actual size of each chamber and its rotor disc can vary from 13-15 inches in diameter upwards to 34-38 inches in diameter. For example, one such embodiment consisting of 6 process chamber and a physical rotor size of 21 inches in diameter and corn-based SG suitable for ethanol production have resulted in an optimized setting of 1,550 rpm having the energy level suitable for a successful liberation of fibers and protein while still keep the fiber sizes intact. Higher amounts of energy per volume based on either higher rpm or a lower feed rate, would likely result in lesser size fiber and smaller protein structures making them harder to later concentrate.

Finally, the feed rate in volume per time unit will affect the end result where low feed rate tends to allocate larger energy per volume and most commonly generates smaller particles in the Librixer.

The air and liberated product mix of fiber and protein mainly are then forced downwards inside the discharge cone, until its spiraling journey is re/directed upwards into an airduct 300 that eventually leads into a bag house for final air purification. The gentle airflow inside the discharge cone is dramatically interrupted via the airduct lip that stick inwards into the cone from the almost vertical airduct. As the inner diameter of the discharge cone becomes smaller the velocity of the rotating fluid stream will increase. When suddenly the air space is increased, larger and heavier liberated fibers and protein structures cannot make the sharp turn and instead drop right down into a rotating airtight valve 400. The airduct is redirected to a vertical set up as soon as possible outside the constraint of the Librixer housing. At a preferred distance from the start of the vertical section a first of possibly several baffles will restrain the air mixed with small light particles again 500. The organized airflow is restrained to pass through a lesser wide section of the airduct inside the baffle. This will increase the velocity of the mixed product, mostly very small and light protein and/or fiber structures and air. As soon as the speed of the mixed fluid has increased it will again resume normal speed when the baffle opens up to tube. At this stage, the larger and heavier particles of the fine light particles will fall out from the flow and be collected just above the baffle via an airtight valve as shown in FIG. 3A. The same procedure can then be repeated in several baffles 600 after selected vertical distances and baffle diameter openings changes before the air stream, now depleted of almost all its particles is finally polished by removing of remaining ultra-fine particles inside a typical baghouse before the clean air is released from the system.

The benefits of this invention, as a method for separating protein and fibers in SG is that a majority of the fine particles such as SG's small protein structures can be smartly removed without further addition of complicated and expensive equipment with the assistance of an already created air movement without further need for energy. In addition, the present invention greatly improves the performance of down-stream separation between larger fiber structures and protein structures by just simple not being there, in the way for such process. The drawings show a 4 stage Librixer. However, it is appreciated that the number of stages may vary from 3 to 6 or more.

FIG. 3B is a schematic drawing of a Librixer liberator/micronizer process stage top view, showing how the spinning material curtain is established by the spinning rotor as the material is introduced to a process stage in the center “C”. The material curtain spinning in either a clockwise or a counterclockwise direction follow an inscribed circle 370 touching the inside edge of each corner vortex generator and the very center of each machine wall as described by the inventor in a prior art disclosure. The enlargement D show where and how the counter to the mainstream rotation direction smaller vortexes are setup on each side of a vortex generator as described in prior art by the inventor of the method in the enclosed embodiment.

FIG. 4 is a schematic drawing of the principles behind an ambient temperature dehydration tunnel technology 408. A closed loop air duct system blows dehydrated air along the bottom of the tunnel. It is recommended from a food safety standard to ionize this air flow. The ionization will neutralize spores and molds as well as many bacteria from the warm moist air being conditioned. The vigorous air movement is further enhanced by several fans pushing and pulling the air across and through the tunnel. The wet SG 402 have shown to have excellent dehydration characteristics based on its large fiber structures in combination with the stiffness of the fibers will maintain porosity in the drying material. The source material stays porous without collapsing as it dries which improves the airflow through the material. The proper thickness of SG is evenly applied on the dehydration surface 401. The dehydration surface is more like a screen consisting of mostly holes 403 for the air to penetrate without the material falling through. The arrangement 410 has a lowest placed dehydration surface L and a highest placed dehydration surface H, as indicated in FIG. 4.

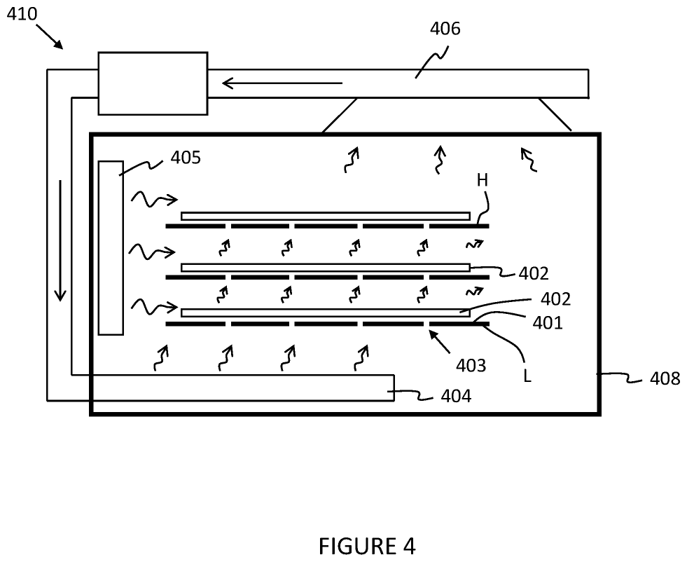

FIG. 5 is a flow chart illustrating methods which summarize the discussion herein. With reference to FIGS. 3A, 3B and 5 in particular, there is illustrated a method for obtaining one or more fiber rich and one or more protein rich fractions from spent grain (SG) 402. The method comprises dehydrating S1 wet spent grain (WSG) 402 into dehydrated spent grain (DSG), by arranging the WSG 402 on at least one dehydration surface 401, wherein the dehydration surface 401 comprises a net or other planar structure with apertures 403 arranged to allow air to penetrate without the spent grain falling through, and

wherein a conditioned air movement system 410 is arranged to move air through the holes 403. The method also comprises comminuting S2 the DSG by a comminution reactor 310 comprising a spinnable shaft 381 and two or more processing chambers 382, separated by segmented divider plates 383, wherein each processing chamber 382 comprises one or more rotor discs A attached to the spinnable shaft 381 and one or more vortex generators D placed at respective apex corners of side walls E of the processing chambers 382, wherein the DSG is fed into the comminution reactor 310 and fiber-rich and protein-rich fractions are liberated from the DSG by means of a non-linear vortex flow of DSG and liberated products generated in the processing chambers 382.

The disclosed methods provide a way to liberate and remove fibers left in the SG. This removal of low protein contents will automatically increase the remaining protein concentration. To be able to do this successfully it is important that the necessary dehydration is done smartly so that the fibers, protein, and fat is not welded together instead, using a gentle ambient temperature system for dehydration all structures are gently collapsed without being glued together. After the dehydrating, the different structures in the SG are gently liberated from each other without micronizing the fibers. Thereafter, the fibers may be separated and removed by different means such as mechanical separation based on size and/or density. As these fiber structures are removed, and they contain very little protein, the protein concentration in the remaining material is going to increase automatically. The end result is a high purity fiber fraction and a high-level raw protein fraction. The disclosed methods are able to reach mid 40% protein concentration with only a loss of protein to the fiber fraction with around 5% protein.

According to aspects, the DSG is associated with a humidity level lower than 15% by weight, and preferably lower than 10% by weight.

According to aspects, the dehydration surface 401 is a flat stationary or slowly rotating drum design.

According to aspects, with reference in particular to FIG. 4, the conditioned air movement system 410 comprises an input duct 404 below the lowest placed dehydration surface L 401 arranged to exhaust dehumidified air, one or more fans 405 arranged to push the dehumidified air along and through the dehydration surface 401 for picking up moisture from the DSG, and a tunnel 406, to create a closed loop system of dehydration space and airducts arranged to evacuate air with high moisture content, lead it into a dehumidifier, and thereafter lead it back to the input duct.

According to aspects, the air inside the conditioned air movement system 410 is arranged to be ionized for purification of the circulating air flow to enhance food safety.

According to aspects, the at least one dehydration surface 401 is arranged in a sealed room. The sealed room may be a rectangular room 408 with size in the range 10-20 meters by 15-25 meters, and wherein a combined dehydration surface of the at least one dehydration surface 401 inside the room 408 has an area in the range of 3000-12000 square meters.

According to aspects, the at least one dehydration surface 401 is loaded with a 2-5 cm thick layer of wet grain 402 that may hold upwards of 60% moisture and 40% dry substance.

According to aspects, the at least one dehydration surface 401 is arranged to roll and wherein the WSG 402 and the DSG are loaded onto and unloaded of, respectively, the dehydration surface 401 automatically.

According to aspects, the method further comprises:

separating S3 ultra-fine protein/bran structures from larger protein/bran structures and fibers of the liberated products by an in-line separation arrangement consisting of one or several vertical baffles 500, 600.

According to aspects, the separation arrangement is a discharge arrangement 320 comprising a main cylindrical cone shaped chamber 302 extending along a main axis 324, the main chamber having an inlet 321 arranged to be fluidly connected to the comminution reactor 310 and an outlet 322 at the bottom of the cone arranged opposite from the inlet 321 along the main axis 324 and closeable by a common material take-out valve 400, wherein the main chamber 302 is arranged to support a fluid-material stream 323 comprising a mix of air and liberated products along a spinning circular path about the main axis 324 from the inlet 321 towards the outlet 322, the discharge arrangement 320 further comprising an airduct 300 arranged extending into the main chamber 302 at an acute angle a with respect to the main axis 324, the airduct 300 comprising an aperture arranged facing the outlet 322, whereby a portion 325 of the fluid-material stream 323, comprising the ultra-fine protein and bran structures mixed with air, changes direction from the fluid-material stream 323 about the main axis 324 from the inlet 321 towards the outlet 322 to a flow inside the airduct 300 and is thereafter arranged to be collected in an ultra-fine particle separator 330, and wherein the larger protein/bran structures and the fibers automatically drop to be collected and discharged in the take-out valve 400.

According to aspects, the comminution reactor 310 and the discharge arrangement 320 are arranged to generate a pressure gradient configured to draw the fluid-material stream through the comminution reactor 310 and to draw the portion 325 of the fluid-material stream 323 in the discharge arrangement 320 into the airduct 300.

According to aspects, the airduct 300 extends into the main chamber 302 at a point about one third of the distance from the outlet 322 to the inlet 321.

According to aspects, the main chamber 302 has a conical shape arranged to support the fluid fluid-material stream 323 from the inlet 321 towards the outlet 322.

According to aspects, the airduct 300 comprises a bend 360 to change extension direction of the airduct 300 into a direction substantially parallel to the main axis 324.

According to aspects, the method further comprises separating S4 the ultra-fine protein/bran structures into heavier and lighter fractions by arranging the ultra-fine particle separator 330 to comprises one or more baffles 600 arranged to restrain the upwards-flowing mix of air and liberated products, and by terminating the ultra-fine particle separator by a filter bag house 340.

According to aspects, the method further comprises separating S5 the larger protein/bran structures from the fibers in an either a shaker screen, air aspirator or an air classifier.

According to aspects, the method further comprises gently crushing S11 the DSG after the dehydration S1 step and before the Librixer liberation and size fractionation S2 step.

According to aspects, the method further comprises centrifuging S01 the WSG 402 to remove surface water, before the dehydration S1 step.

According to aspects, the comminution reactor 310 comprises between 2 and 10 processing chambers 382, and preferably 6 processing chambers.

According to aspects, the size of each processing chamber 382 and its respective rotor disc A is between 13-34 inches in diameter, and preferably 21 inches in diameter.

According to aspects, the process chamber A comprises of an odd number of vortex generators D.

According to aspects, the rotor disc A is configured to rotate at between 1300-1600 revolutions per minute and preferably at 1500 revolutions per minute.

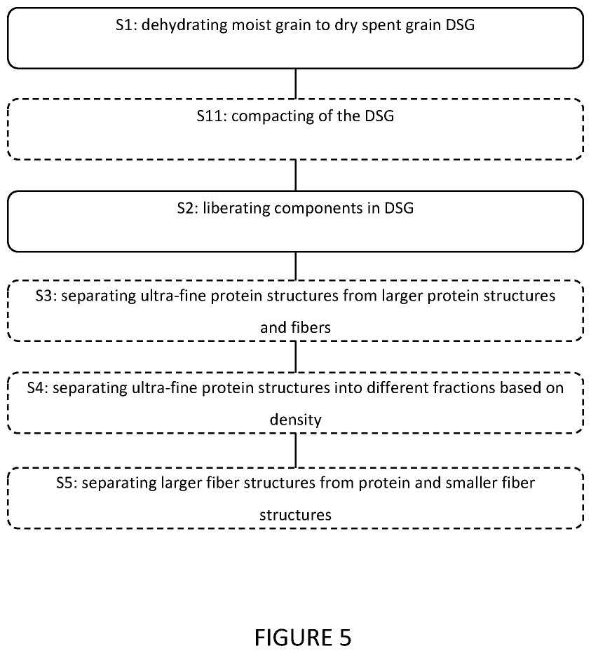

FIG. 6 schematically illustrates, in terms of a number of functional units, the general components of a control unit 600. Processing circuitry 610 is provided using any combination of one or more of a suitable central processing unit CPU, multiprocessor, microcontroller, digital signal processor DSP, etc., capable of executing software instructions stored in a computer program product, e.g. in the form of a storage medium 630. The processing circuitry 610 may further be provided as at least one application specific integrated circuit ASIC, or field programmable gate array FPGA.

Particularly, the processing circuitry 610 is configured to cause the Librixer system to perform a set of operations, or steps, such as the methods discussed in connection to FIG. 5 and the discussions above, and also to set the operating parameters of the Librixer system according to the discussions above. For example, the storage medium 630 may store the set of operations, and the processing circuitry 610 may be configured to retrieve the set of operations from the storage medium 630 to cause the device to perform the set of operations. The set of operations may be provided as a set of executable instructions. Thus, the processing circuitry 610 is thereby arranged to execute methods as herein disclosed.

The storage medium 630 may also comprise persistent storage, which, for example, can be any single one or combination of magnetic memory, optical memory, solid state memory or even remotely mounted memory. This storage medium may be configured to store one or more sets of configuration settings for the Librixer system.

The device 600 may further comprise an interface 620 for communications with at least one external device. As such the interface 620 may comprise one or more transmitters and receivers, comprising analogue and digital components and a suitable number of ports for wireline or wireless communication.

The processing circuitry 610 controls the general operation of the control unit 600, e.g., by sending data and control signals to the interface 620 and the storage medium 630, by receiving data and reports from the interface 620, and by retrieving data and instructions from the storage medium 630.

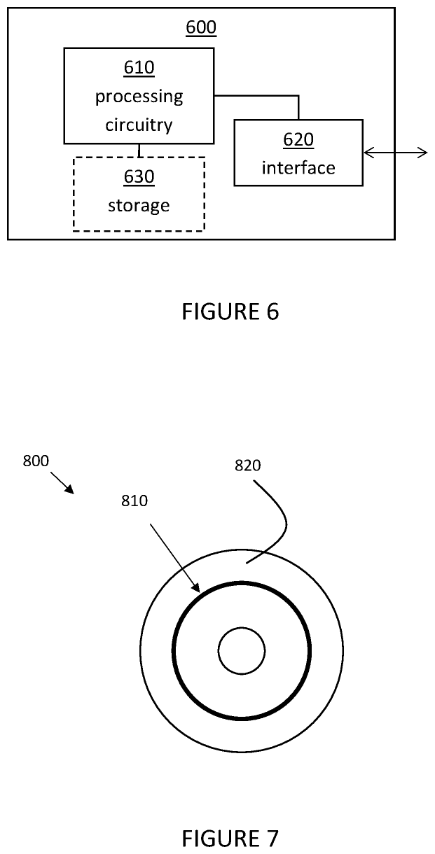

FIG. 7 illustrates a computer readable medium 810 carrying a computer program comprising program code means 820 for performing the methods illustrated in FIG. 4 and/or for executing the various functions discussed above, when said program product is run on a computer. The computer readable medium and the code means may together form a computer program product 700. This computer program product may comprise one or more sets of configurations for controlling the Librixer system discussed above to perform the methods disclosed herein.

1. A method for obtaining one or more fiber rich and one or more protein rich fractions from spent grain, SG, (402), the method comprising:
dehydrating (S1) wet spent grain, WSG, (402) into dehydrated spent grain, DSG, by arranging the WSG (402) on at least one dehydration surface (401),
wherein the dehydration surface (401) comprises a planar structure with apertures (403) arranged to allow air to penetrate without the spent grain falling through, and wherein a conditioned air movement system (410) is arranged to move air along above and below the dehydration surfaces and through the apertures (403) and past the SG (403), and
comminuting (S2) the DSG by a comminution reactor (310) comprising a spinnable shaft (381) and two or more processing chambers (382), separated by segmented divider plates (383),
wherein each processing chamber (382) comprises one rotor disc (A) attached to the shaft (381) and one or more vortex generators (D) placed at respective apex corners of stationary side walls (E) of the processing chambers (382),
wherein the DSG is fed into the comminution reactor (310) and fiber-rich and protein-rich fractions are liberated from the DSG by means of a non-linear vortex flow of DSG and liberated products generated in the processing chambers (382).

2. The method according to claim 1, wherein the DSG has a humidity level lower than 15% by weight.

3. The method according to claim 1, wherein the dehydration surface (401) is a flat stationary design.

4. The method according to claim 1, wherein the conditioned air movement system (410) comprises an input duct (404) below the lowest placed dehydration surface (401, L) arranged to exhaust dehumidified air, one or more fans (405) arranged to push the dehumidified air along and through the dehydration surface (401) for picking up moisture from the DSG, and a tunnel (406), to create a closed loop system of dehydration space and airducts arranged to evacuate air with high moisture content, lead it into a dehumidifier, and thereafter lead it back to the input duct.

5. The method according to claim 4, where the air inside the conditioned air movement system (410) is arranged to be ionized for air purification and food safety.

6. The method according to claim 1, wherein the at least one dehydration surface (401) is arranged in a sealed room.

7. The method according to claim 6, wherein the sealed room is a rectangular room (408) with size in the range 10-20 meters by 15-25 meters, and wherein a combined dehydration surface of the at least one dehydration surface (401) inside the room (408) has an area in the range of 3000-12000 square meters.

8. The method according to claim 1, wherein the at least one dehydration surface (401) is loaded with a 2-5 cm thick layer of wet grain (402) that may hold upwards of 60% moisture and 40% dry substance.

9. The method according to claim 1, wherein the at least one dehydration surface (401) is arranged as a rotating drum and wherein the WSG (402) and the DSG are loaded onto and unloaded of, respectively, the dehydration surface (401) automatically.

10. The method according to claim 1, further comprising the steps of: separating (S3) ultra-fine protein/bran structures from larger protein/bran structures and fibers of the liberated products by an in-line separation arrangement consisting of at least one vertical baffles.

11. The method according to claim 10, wherein the separation arrangement is a discharge arrangement (320) comprising a main cylindrical cone shaped chamber (302) extending along a main axis (324), the main chamber having an inlet (321) arranged to be fluidly connected to the comminution reactor (310) and an outlet (322) at the bottom of the cone arranged opposite from the inlet (321) along the main axis (324) and closeable by a common material take-out valve (400), wherein the main chamber (302) is arranged to support a fluid-material stream (323) comprising a mix of air and liberated products along a spinning circular path about the main axis (324) from the inlet (321) towards the outlet (322), the discharge arrangement (320) further comprising an airduct (300) arranged extending into the main chamber (302) at an acute angle (a) with respect to the main axis (324), the airduct (300) comprising an aperture arranged facing the outlet (322),
whereby a portion (325) of the fluid-material stream (323), comprising the ultra-fine protein and bran structures, changes direction from the fluid-material stream (323) about the main axis (324) from the inlet (321) towards the outlet (322) to a flow inside the airduct (300) and is thereafter arranged to be collected in an ultra-fine particle separator (330), and wherein the larger protein/bran structures and the fibers automatically drop to be collected and discharged in the take-out valve (400).

12. The method according to claim 11, wherein the comminution reactor (310) and the discharge arrangement (320) are arranged to generate a pressure gradient configured to draw the fluid-material stream through the comminution reactor (310) and to draw the portion (325) of the fluid-material stream (323) in the discharge arrangement (320) into the airduct (300).

13. The method according to claim 11, wherein the airduct (300) extends into the main chamber (302) at a point about one third of the distance from the outlet (322) to the inlet (321).

14. The method according to claim 11, wherein the main chamber (302) has a conical shape arranged to support the fluid fluid-material stream (323) from the inlet (321) towards the outlet (322).

15. The method according to claim 11, wherein the airduct (300) comprises a bend (360) to change extension direction of the airduct (300) into a direction substantially parallel to the main axis (324).

16. The method according to claim 11, further comprising the step of separating (S4) the ultra-fine protein/bran structures into heavier and lighter fractions by arranging the ultra-fine particle separator (330) to comprise one or more baffles (600) arranged to restrain the upwards-flowing mix of air and liberated products, and by terminating the ultra-fine particle flow inside a filter bag house (340).

17. The method according to claim 1 further comprising the step of separating (S5) the larger protein/bran structures from the fibers on either a shaker table, an air aspirator or in an air classifier.

18. The method according to claim 1, further comprising gently crushing (S11) the DSG after the (S1) step and before the Librixer liberation and size fractionation (S2) step.

19. The method according to claim 1, further comprising the step of centrifuging (S01) the WSG (402) to remove surface water, before the dehydration (S1) step.

20. The method according to claim 1, wherein the comminution reactor (310) comprises between 2 and 10 processing chambers (382).

21. The method according to claim 1, wherein the size of each processing chamber (382) and its respective rotor disc (A) is between 13-34 inches in diameter.

22. The method according to claim 1, wherein the process chamber (A) comprises of an odd number of vortex generators (D).

23. The method according to claim 1, wherein the rotor disc (A) is configured to rotate at between 1300-1600 revolutions per minute.

24. A system arranged for obtaining one or more fiber rich and one or more protein rich fractions from spent grain, SG, (402), the system comprising:
a conditioned air movement system (410) arranged to dehydrate wet spent grain, WSG, (402) into dehydrated spent grain, DSG, by arranging the WSG (402) on at least one dehydration surface (401),
wherein the dehydration surface (401) comprises a planar structure with apertures (403) arranged to allow air to penetrate without the spent grain falling through, and
wherein the conditioned air movement system (410) is arranged to move air along above and below the dehydration surfaces and through the apertures (403) and past the SG (403),
the system further comprising a comminution reactor (310) arranged to comminute the DSG, the reactor comprising a spinnable shaft (381) and two or more processing chambers (382), separated by segmented divider plates (383),
wherein each processing chamber (382) comprises one rotor disc (A) attached to the shaft (381) and one or more vortex generators (D) placed at respective apex corners of stationary side walls (E) of the processing chambers (382), and
wherein the DSG is arranged to be fed into the comminution reactor (310) and fiber-rich and protein-rich fractions are liberated from the DSG by means of a non-linear vortex flow of DSG and liberated products generated in the processing chambers (382).

25-26. (canceled)
